(19) United States
(12) Patent Application Publication
(10) Pub. No.: US 2011/0043444 A1
(43) Pub. Date: Feb. 24, 2011

(54) PORTABLE ELECTRONIC DEVICE

(75) Inventor: CHING-CHIN PUN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/721,639

(22) Filed: Mar. 11, 2010

(30) Foreign Application Priority Data
Aug. 24, 2009 (CN) 200910305998.5

(51) Int. Cl. G06F 3/01

(52) U.S. Cl. 345/156

(57) ABSTRACT

An exemplary portable electronic device includes a main body, a cover movably connected with the main body, a piezoelectric sensing unit, and a signal processing unit. The piezoelectric sensing unit is partially positioned on the main body and the cover. The piezoelectric sensing unit generates elastic deformation due to the relative displacement of the cover and the main body to generate a corresponding command signal. The signal processing unit is electrically connected to the piezoelectric sensing unit, and capable of actuating different modes of the portable electronic device according to the command signal.

### BACKGROUND

1. Technical field

The disclosure generally relates to portable electronic devices, more particularly, to a portable electronic device with flipping structure.

2. Description of the Related Art

Nowadays, flipping structures are widely used in mobile phones, personal digital assistants (PDAs) and other portable electronic devices. A flip-type electronic device generally has a main body and a flip cover. When the flip cover is rotated or flipped relative to the main body to a different position, the portable electronic device then can be switched to corresponding modes.

Generally, most portable electronic devices switch to different modes previously associated with the movements of the flip cover by magnetic induction. A magnetic sensing device and a corresponding magnetic device are respectively disposed in the main body and the flip cover. When the flip cover rotates or flips relative to the main body to a different position, the magnetic sensing device and the magnetic device have a relative displacement; the magnetic sensing device then generates a command signal, so that the portable electronic devices can invoke different modes. However, even though the magnetic devices may be small they still increase the size and weight of the portable electronic device.

Therefore, there is room for improvement within the art.

### BRIEF DESCRIPTION OF THE DRAWINGS

Many aspects of a portable electronic device can be better understood with reference to the following drawings. The components in the drawings are not necessarily drawn to scale, the emphasis instead being placed upon clearly illustrating the principles of the exemplary portable electronic device. Moreover, in the drawings, like reference numerals designate corresponding parts throughout the several views. Wherever possible, the same reference numbers are used throughout the drawings to refer to the same or like elements of an embodiment.

FIG. 1 is a schematic view of a portable electronic device in a closed position, according to an exemplary embodiment.

FIG. 2 is similar to FIG. 1, but showing the portable electronic device in an open position.

FIG. 3 is a side schematic view of the portable electronic device shown in FIG. 1.

FIG. 4 is a side schematic view of the portable electronic device shown in FIG. 2.

FIG. 5 is a partial functional block view of the portable electronic device shown in FIG. 1.

### DETAILED DESCRIPTION

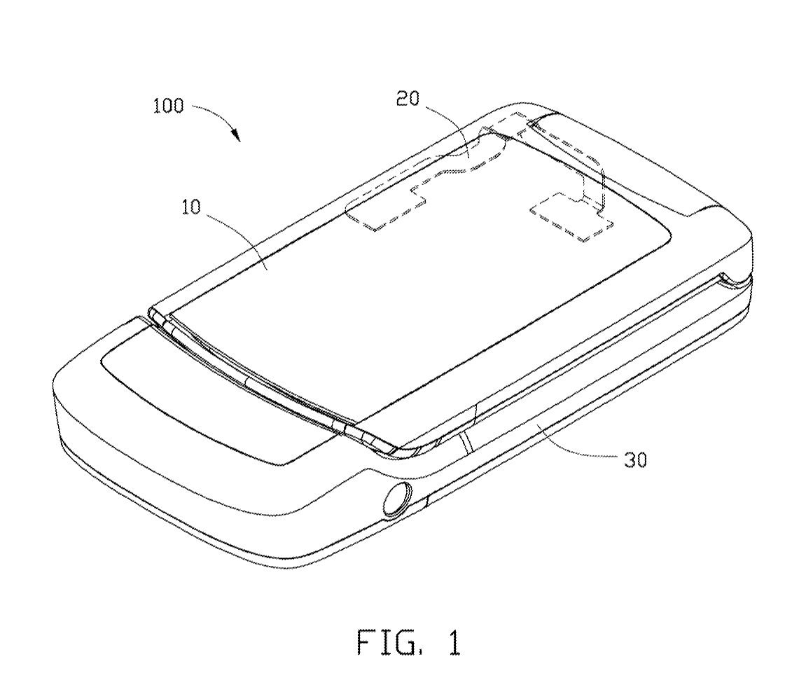

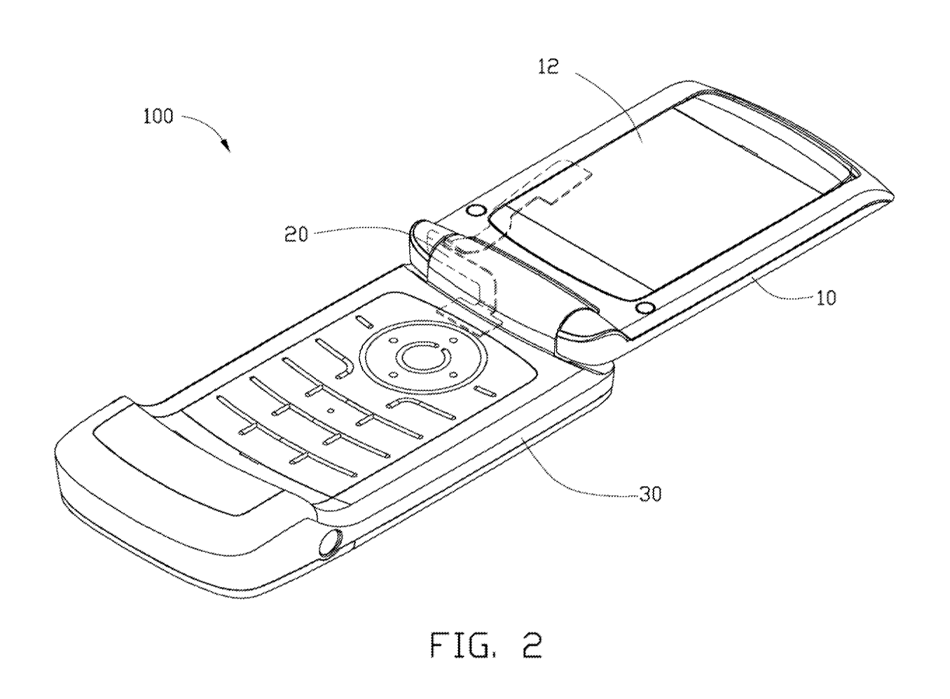

FIGS. 1-2 show an exemplary embodiment of a portable electronic device 100, which may be a PDA, a mobile phone, etc. The portable electronic device 100 may have a sliding structure or a flipping structure, a mobile phone with a flipping structure is used here as an exemplary application.

The portable electronic device 100 includes a cover 10, a piezoelectric sensing unit 20, and a main body 30. The cover 10 can be rotatably/movably connected to the main body 30. In this embodiment, the open position of the cover 10 is defined as a first position, and the closed position of the cover 10 is defined as a second position.

The portable device 100 further includes a display unit 12 centrally located in the cover 10, which can be integrated with an existing liquid crystal display module (LCM) of the mobile phone. The display unit 12 displays various information and operation instructions corresponding to different modes. When the cover 10 is flipped relative to the main body 30 to a different position, the display unit 12 accordingly works in corresponding modes. For example, when the cover 10 is in the first position, the display unit 12 may work in a startup mode or an operational mode; when the cover 10 is in the second position, the display unit 12 may be in a protected mode, a standby mode, a sleep mode, a screen saver mode, and so on.

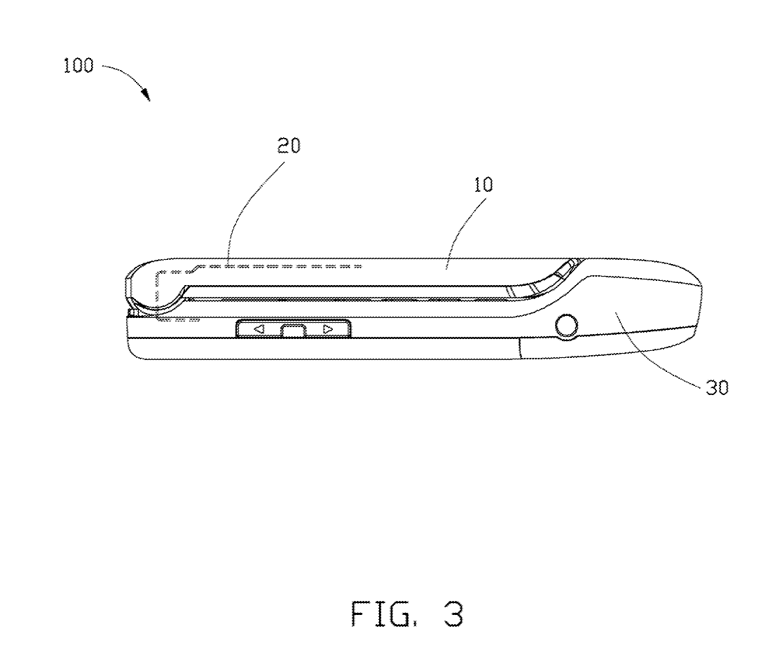

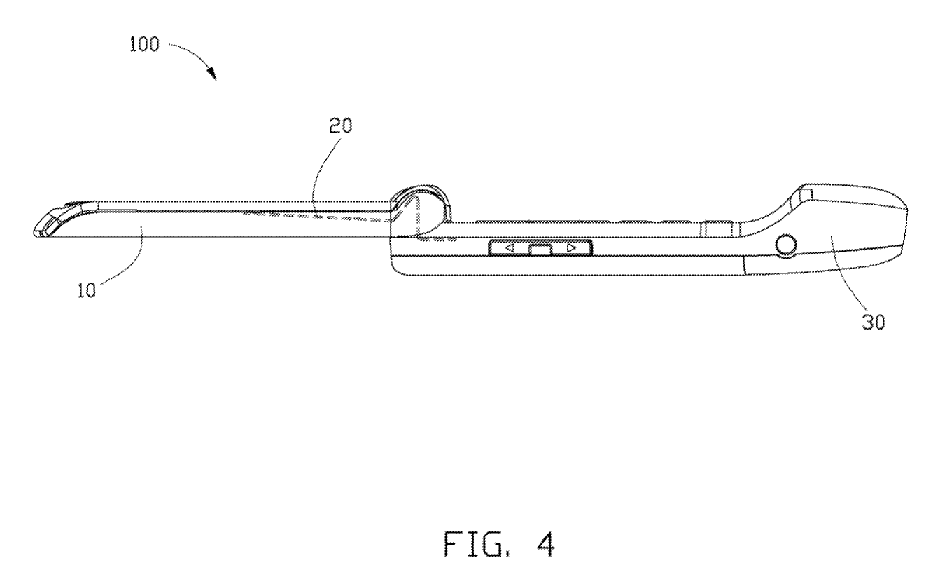

Referring to FIGS. 3 and 4, the piezoelectric sensing unit 20 may be a sheet shape and made from a piezoelectric material, such as BaTiO3, PbZrxTi(1−x)O3 (PZT), etc. Two ends of the piezoelectric sensing unit 20 are respectively fixed on the cover 10 and the main body 30. According to the characteristics of the piezoelectric material, when the piezoelectric sensing unit 20 is deformed such as due to torsion, folding or bending, it accordingly generates a command signal. Thus, when the cover 10 is opened or closed, the piezoelectric sensing unit 20 elastically deforms and correspondingly generates a first command signal or a second command signal. Moreover, the piezoelectric sensing unit 20 can be integrated with an existing flexible printed circuit board (FPC) to further reduce space used.

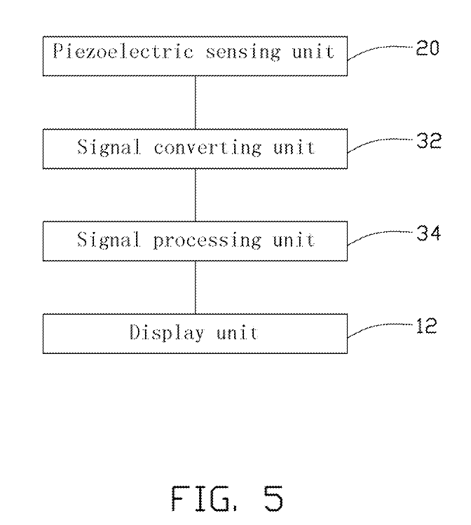

Referring to FIG. 5, the main body 30 includes a circuit board (not shown) which may be an existing printed circuit board (PCB). The circuit board is positioned in the main body 30 and includes a signal converting unit 32 and a signal processing unit 34. The signal converting unit 32 is electrically connected to the piezoelectric sensing unit 20 and the signal processing unit 34, and the signal processing unit 34 is electrically connected to the display unit 12.

The signal converting unit 32 can be an existing analog/digital signal converter. The signal converting unit 32 receives the command signal from the piezoelectric sensing unit 20, transforms the command signal into corresponding digital signal, and transmits the digital signal to the signal processing unit 34.

The signal processing unit 34 can be integrated with the central processing unit (CPU) of the portable electronic device 100. The signal processing unit 34 receives the digital signal from the signal converting unit 32 and generates a corresponding control signal after processing the digital signal, so that the signal processing unit 34 can control the portable electronic device 100 and the display unit 12 to work in different modes depending on the received control signal. For example, when the signal processing unit 32 determines the cover 10 is in the open position, the signal processing unit 32 controls the display unit 12 to work in the startup mode or the operational mode; when the signal processing unit 32 determines the cover 10 is the closed position, the signal processing unit 32 controls the display unit 12 to work in protected mode, standby mode, sleep mode, screen saver mode, etc.

Referring to FIGS. 1-2, in use, when the portable electronic device 100 is moved to the first position, the cover 10 is opened, the movement of opening the cover 10 bends the piezoelectric sensing unit 20 away from the main body 30. When the portable electronic device 100 is moved to the second position, the cover 10 is closed, the closing movement of closing the cover 10 bends the piezoelectric sensing unit 20 close to the main body 30. Thus, the piezoelectric sensing unit 20 generates corresponding command signals based on type of elastic deformation caused by the bending. The signal converting unit 32 receives the command signal from the piezoelectric sensing unit 20 and transforms the command signal into corresponding digital signal. The signal processing unit 34 receives and processed the digital signal to generate a corresponding control signal. The signal processing unit 34 controls the portable electronic device 100 to work in different modes according to the type of control signal. Thus, the portable electronic device 100 adopts different modes under the control of the signal processing unit 34.

Similarly, when the portable electronic device is a sliding type electronic device, the cover can be slidably/movably connected with the main body. The piezoelectric sensing unit is respectively fixed on the cover and the main body. When the cover is opened or closed relative to the main body, the piezoelectric sensing unit is stretched or partially compressed to generate corresponding command signals. Thus, the signal processing unit can control the portable electronic device and the display unit to work in different work positions or modes according to the type of control signal.

In the portable electronic device 100 of the exemplary embodiment, when the cover 10 is opened or closed relative to the main body 30, the piezoelectric sensing unit 20 is elastically deformed and generates a corresponding command signal, so the portable electronic device 100 may work in different modes. Moreover, the piezoelectric sensing unit 20 has a smaller size and weight, reducing the size and weight of the portable electronic device 100. There is no need to add additional magnetic device and magnetic sensing device in the cover 10 or the main body 30, so that the size, weight and cost of the portable electronic device 100 are reduced.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A portable electronic device, comprising:
a main body;
a cover movably connected with the main body;
a piezoelectric sensing unit partially positioned on the main body and the cover, the piezoelectric sensing unit being elastically deformed due to the relative displacement of the cover and the main body and capable of generating a corresponding command signal depending on the type of elastic deformation; and
a signal processing unit electrically connected to the piezoelectric sensing unit, wherein the signal processing unit is capable of actuating different modes of the portable electronic device according to the received command signal.

2. The portable electronic device as claimed in claim 1, further comprising a signal converting unit electrically connected to the piezoelectric sensing unit and the signal processing unit, wherein the signal converting unit receives the command signal from the piezoelectric sensing unit and transforms the command signal into a corresponding digital signal.

3. The portable electronic device as claimed in claim 1, wherein the cover comprises a display unit electrically connected to the signal processing unit, and the display unit displays various information and operation instructions corresponding to different modes.

4. The portable electronic device as claimed in claim 3, wherein when the cover is opened, the piezoelectric sensing unit generates elastic deformations and generates a first command signal, the signal processing unit then controls the portable electronic device and the display unit to work in one mode according to the first command signal.

5. The portable electronic device as claimed in claim 4, wherein when the cover is closed, the piezoelectric sensing unit generates elastic deformation and generates a second command signal, the signal processing unit then controls the portable electronic device and the display unit to work in another mode according to the second command signal.

6. The portable electronic device as claimed in claim 2, further comprising a circuit board, the circuit positioned in the main board, and the signal converting unit and the signal processing unit being positioned on the circuit board.

7. The portable electronic device as claimed in claim 1, wherein the piezoelectric sensing unit is integrated with a flexible printed circuit board.

8. The portable electronic device as claimed in claim 1, wherein the piezoelectric sensing unit is made from piezoelectric material.

9. A portable electronic device, comprising:
a main body;
a cover movably connected with the main body;
a piezoelectric sensing unit for detecting elastic deformation due to the relative movement of the cover and the main body and capable of correspondingly generating a command signal;
a signal converting unit electrically connected to the piezoelectric sensing unit, and the signal converting unit receiving the command signal and capable of transforming the command signal from the piezoelectric sensing unit to a second signal; and
a signal processing unit electrically connected to the signal converting unit, wherein the signal processing unit is capable of receiving and processing the second signal from the signal converting unit to actuate different modes of the portable electronic device.

10. The portable electronic device as claimed in claim 9, wherein the cover comprises a display unit electrically connected to the signal processing unit, and the display unit displays various information and operation instructions corresponding to different modes.

11. The portable electronic device as claimed in claim 10, wherein when the cover is opened, the piezoelectric sensing unit generates elastic deformations generating a first command signal, the signal processing unit then controls the portable electronic device and the display unit to work in one mode according to the first command signal.

12. The portable electronic device as claimed in claim 11, wherein when the cover is closed, the piezoelectric sensing unit generates elastic deformation generating a second command signal, the signal processing unit then controls the portable electronic device and the display unit to work in another mode according to the second command signal.

13. The portable electronic device as claimed in claim 9, further comprising a circuit board, the circuit positioned in the main board, and the signal converting unit and the signal processing unit being positioned on the circuit board.

14. The portable electronic device as claimed in claim 9, wherein the piezoelectric sensing unit is integrated with a flexible printed circuit board.

15. The portable electronic device as claimed in claim 9, wherein the piezoelectric sensing unit is made from piezoelectric material.

16. The portable electronic device as claimed in claim 9, wherein the signal converting unit transforms the command signal from the piezoelectric sensing unit into a digital signal.
